(19) United States
(12) Patent Application Publication
(10) Pub. No.: US 2010/0157307 A1
(43) Pub. Date: Jun. 24, 2010

(54) Sensor and an imaging system for remotely detecting an object

(75) Inventors: Frederic TAILLADE, Clamart (FR); Etienne BELIN, Angers (FR)

Correspondence Address: KENYON & KENYON LLP, 1500 K STREET N.W., SUITE 700, WASHINGTON, DC, 20005, US

(73) Assignee: LABORATOIRE CENTRAL DES PONTS ET CHAUSSEES, Paris (FR)

(21) Appl. No.: 12/641,785

(22) Filed: Dec. 18, 2009

(30) Foreign Application Priority Data
Dec. 18, 2008 (FR) 0858758

(51) Int. Cl. G01B 9/021

(52) U.S. Cl. 356/457

(57) ABSTRACT

A sensor for remotely detecting an object, the sensor comprising:
a light source having a coherence length that is short relative to the distance between the sensor and the object;
a splitter splitting the emitted light beam into an incident beam and a reference beam;
a photorefractive crystal recording a hologram on interfering reception of the reference beam and of the reflected beam reflected by an object illuminated by the incident beam, and playing back the hologram in a diffracted beam that is re-emitted by the crystal by anisotropic diffraction under the effect of the reference beam;
a detector recording information on receiving the diffracted beam; and
a polarizing filter that eliminates the major fraction of the reflected beam as transmitted by the crystal on receiving the reflected beam; such that the detector receives only the diffracted beam from the crystal. Both the sensor and imaging systems incorporating the sensor enable measurements to be made through diffusing media.

### FIELD OF THE INVENTION

The invention relates to remotely measuring the position and/or the shape of an object, in particular when the object is situated in a diffusing medium. Three applications are envisaged more particularly:

on a large scale, measuring the movements and/or the distances of targets (whether co-operating or otherwise), in particular in unfavorable weather conditions;

on a medium scale, for a vehicle traveling on a road, detecting and/or identifying obstacles or other vehicles through fog or rain; and

on a small scale, measuring cellular structures within biological tissues.

### BACKGROUND OF THE INVENTION

Various technological solutions are known for remotely measuring the position of an object. Some are partially suitable for making measurements in a diffusing medium.

Firstly, at a large scale, it is known to make use of theodolites for measuring the relative positions of objects. Such sensors consist in emitting an infrared laser beam to strike reflecting targets and in measuring the go-and-return travel time thereof. In bad weather (rain, snow, fog), the signal is interrupted.

Radars enable the relative positions of reflecting targets to be measured under unfavorable weather conditions with good accuracy, but at high cost.

In the driving-assistance field, it is known to make use of active sensors of the radar or lidar type to detect obstacles or vehicles, e.g. on a road. Such sensors can be used to some extent in weather conditions of fog or rain. The principle on which such sensors are based consists in emitting an electromagnetic signal towards the scene that is to be characterized, and in analyzing the echo that it returns. Nevertheless, neither of those two types of sensor is entirely satisfactory:

radars present poor lateral resolution, with angular fields of view that are very narrow, a few degrees only, thus making them unsuitable for detecting vehicles traveling on wide roads or on winding roads. Furthermore, radars are poor or useless at detecting stationary obstacles situated beside the road or even on it. Finally, when faced with an environment that is complex, radars receive multiple echoes and it is found to be difficult to interpret the received data; and

lidars constitute a transposition of radars into the optical range, with the microwave transmitter of a radar typically being replaced by a laser. A lidar sensor is thus constituted by an emitter, reception optics, and an electronic system for analyzing signals as received in return. These constitute “travel time” sensors. The principal drawback of lidars is that their performance becomes greatly degraded when weather conditions are unfavorable, e.g. when it is desired to use them through fog or rain. In addition, lidars are found to be highly sensitive to the surface state of the measured object; as a result, their performance is very variable, and that might make it necessary for all vehicles that need to be detected on a road to be fitted with retroreflectors, where appropriate.

Furthermore, in the field of measuring cell structures in living tissues, which constitute highly diffusing media, other measurement systems are used, which systems are known only for taking measurements at very small scales. The technical principal used relies on a conventional interferometry technique known as optical coherence tomography (OCT) that is used in particular in known manner for making tools for providing medical diagnosis assistance in vivo.

The principle of optical coherence tomography is shown in FIG. 1. This figure shows an imaging system comprising a light source constituted by a laser source 10; a beam splitter cube 12; a mirror 14; and a detector 16 that is generally constituted by a charge-coupled device (CCD) camera. These various elements are arranged to form a Michelson type interferometer. In that imaging system, the light source 10 projects a “source” light beam 22 towards the tissue 18 for measurement. Inside the tissue, there are organelles 20 in positions that are to be determined. The splitter cube is placed on the path of the source beam 22. It splits it into a reference beam 23 that is directed towards the mirror 14 and an incident beam 26 that strikes the tissue 18. The mirror 14 is disposed perpendicularly to the reference beam 23; it thus returns it in the direction from which it came, so that, after striking the mirror 14, a fraction of the reference beam 23 passes back through the splitter cube 12 and is then directed towards the lens 28 of the camera 16. After striking the mirror 14, the other fraction of the reference beam 23 returns towards the light source 10.

On reaching the tissue 18, the incident beam 26 is reflected thereby, and is mainly reflected by the organelles 20 disposed therein (only one organelle is shown). A fraction of the retroreflected beam 27 is deflected through a right angle by the splitter cube towards the camera 16. The other fraction of the retroreflected beam 27 passes through the cube towards the light source 10. This setup thus enables a fraction of the beam 27 reflected by the object, in particular reflected by the tissue 18 that is to be measured, to be combined with a fraction of the beam 23 that has followed a reference path. Combining these two beams, the reference beam 23 and the reflected beam 27, gives rise to interference, providing the difference between the optical path lengths traveled by the two beams (23; 26+27) is shorter than the coherence length of the light source 10 used.

Although such imaging systems provide useful results when they are used to measure objects in a non-diffusing medium, their performance becomes greatly degraded when it is necessary to measure objects placed in a diffusing medium, e.g. organelles 20 incorporated in living tissue 18. This is due in particular to the fact that in the imaging system shown in FIG. 1, the useful information constitutes only a small fraction of the information received by the camera 16. Thus, in order to improve the metrological performance of such a system, the information needs to be subjected to a large amount of signal processing, usually in association with an electromechanical device for moving the mirror 14 so as to make use of the phase-shift technique, which requires several measurements to be taken sequentially for each phase shift, other things remaining equal. These constraints increase the complexity and the price of such systems, and in addition they limit them to being used for making static observations.

### OBJECT AND SUMMARY OF THE INVENTION

Given the drawbacks and limitations of those various systems, the objective of the invention is to propose a sensor that is relatively simple and that comprises:

a light source suitable for emitting a source light beam;

a beam splitter suitable for receiving the source light beam and for splitting it into an incident beam and a reference beam, which beams are transmitted respectively in two distinct directions;

a photorefractive crystal suitable for recording a hologram on receiving the reference beam and a reflected beam reflected by an object illuminated by the incident beam, the two beams interfering, and for playing back the hologram in a diffracted beam that is emitted when the crystal is illuminated by the reference beam, the crystal being cut and located in the sensor in such a manner as to enable the reference beam to be diffracted anisotropically, thereby causing the diffracted beam to be emitted with polarization perpendicular to the polarization of the reflected beam transmitted by the crystal;

a detector suitable for recording or fixing information on receiving the diffracted beam; and

a polarization filter interposed between the crystal and the detector, and suitable for eliminating from the beam emitted by the crystal towards the detector, the major fraction of the transmitted reflected beam as transmitted by the crystal on receiving the reflected beam, such that the detector mainly receives from the crystal only the diffracted beam;

the sensor being suitable for enabling the position and optionally the shape of an object to be determined remotely, measurement preferably remaining possible even through a diffusing medium.

This objective is achieved by virtue of the fact that the light source has a coherence length that is short relative to the distance between the sensor and the object.

The polarization filter is a filter that makes use of a polarization difference to perform a filtering operation on the beam. In the sensor of the invention, the filter eliminates the major fraction of the transmitted reflected beam, but without affecting the diffracted beam. The diffracted beam is emitted substantially unchanged towards the detector.

The filtering operation is performed by the combination of the photorefractive crystal and the filter that is interposed between the crystal and the detector. It serves to eliminate the noise signal, or at least to separate it from the wanted signal (i.e. the diffracted signal), where the noise signal is the transmitted reflected beam, which is the retransmission by the photorefractive crystal of the signal reflected by the object (which beam includes in particular radiation that has been diffused by the diffusing environment surrounding the object to be measured or situated between the sensor and the object to be measured). By means of this filtering, the sensor of the invention presents a very large measurement dynamic range, i.e. it enables acquisitions to be performed that present very high signal-to-noise ratio. It is this property that enables it to be used without having recourse to complex signal processing, even for measurements that are made through a diffusing medium.

Naturally, the operation of the sensor requires a hologram to be formed in the photorefractive crystal, and thus it requires interference to form between the reference beam and the reflected beam returned by the object for measurement.

For such interference to take place, it is necessary for the path length difference between the optical path of the reference beam and the total optical path of the incident beam plus the reflected beam to be shorter than the coherence length of the source, such that the encounter between those two beams gives rise to interference.

To a first approximation, this condition, which relates indirectly to the distance between the sensor and the object, defines the position of the measurement volume of the sensor to within the coherence length of the light source, this being the only volume in which the sensor can detect an object and provide information relating thereto.

Because of this condition, when the beam splitter is close to the photorefractive crystal, the measurement volume is situated remotely from the sensor at a distance that is about half the optical path length of the reference beam.

In certain embodiments, the distance traveled by the reference beam has a fixed value linked to the structure of the sensor. Under such circumstances, the measurement volume is situated at a fixed distance from the sensor (possibly a long distance), with the above condition being satisfied at that distance.

In contrast, in other embodiments, the optical path length of the reference beam may be varied, e.g. by causing the reference beam to travel along an optical delay line constituted by at least two mirrors, or along an optical fiber. The optical fiber may be wound as a coil: it is then easy to modulate the length of the optical fiber and thus the optical path length of the reference beam. The measurement volume is situated at a distance from the sensor that is substantially equal to half the length of the optical fiber.

Furthermore, another important parameter of the sensor is the coherence length of the light source. The depth of the measurement volume (in the propagation direction of the incident beam) is close to half the coherence length, and it cannot exceed that value.

The coherence length of the light source performs the following role: a hologram can be formed by the photorefractive crystal only if there is interference between the reference signal and the reflected signal striking it. This interference can take place only if the respective optical paths along which these two beams travel differ by a length that is no greater than the coherence length of the source. If the coherence length is short, then the sensor detects the position of a measured object only in a volume of shallow depth (in the propagation direction of the incident beam); on the contrary, if the coherence length of the light source is long, then the sensor is sensitive to any object lying within a slice of considerable depth.

The sensor of the invention makes use of this property to present high separating power, i.e. great capacity to select elements for measurement as a function of their positions in the measurement direction (direction of the incident beam). When the sensor is used for measuring distances, this capacity advantageously gives rise to good or even excellent accuracy.

Thus, and advantageously, the fact that the light source presents a coherence length that is short compared with the distance between the sensor and the object means that the measurement volume contains all or part of the object, and conversely contains little or none of anything that is to be found between the sensor and the object. A coherence length that is “short” compared with the distance between the sensor and the object is defined herein as a length that is less than ⅕th of said distance. Preferably, the coherence length of the source may be less than 1/50th of said distance.

The structure of the sensor makes it possible to ensure that nothing located outside the measurement volume between the sensor and the object degrades the quality of the signal obtained by the detector of the sensor. This makes it possible to perform measurements even in a diffusing medium. The light source may be a light emitting diode (LED) or a halogen lamp, since these two types of light source present coherence lengths that are short.

Another advantage of the sensor lies in the fact that it is self-aligning: it does not require the photorefractive crystal to be accurately aligned relative to other elements of the sensor, e.g. the beam splitter.

Furthermore, and advantageously, the sensor is relatively simple, insofar as it includes only one light source, the reference beam being used both to form the hologram in the photorefractive crystal and to read it. It follows that the cost of manufacturing the sensor remains relatively low.

In an embodiment, the light source and the detector are suitable for operating substantially continuously, such that when the sensor is in operation, the hologram is formed and read simultaneously and continuously. Thus, and advantageously, the sensor enables measurements to be performed continuously at a frequency that depends on the ability of the photorefractive crystal to update the hologram. By virtue of this continuous operation, the sensor is relatively simple to implement and to control, and its cost remains low. An example of a detector that operates “substantially continuously” is a CCD camera, that produces successive images at a given frequency, but without stopping between two acquisitions.

In one embodiment, the filter includes a polarizer that is suitable for eliminating from the beam emitted by the crystal towards the detector the major fraction of the transmitted reflected beam. The polarizer makes use of the anisotropy property of diffraction by the photorefractive crystal, whereby the transmitted reflected beam is polarized perpendicularly to the diffracted waves. This makes it possible in very simple and inexpensive manner to eliminate light components other than those constituting the diffracted beam from the beam that is transmitted to the detector.

In an embodiment, the filter comprises a polarization splitter cube that is suitable for acting on the beam that is emitted from the crystal towards the detector to separate the major fraction of the transmitted reflected beam from the diffracted beam, and to direct said major fraction of the transmitted reflected beam in a direction other than towards the detector. The splitter cube then generally takes the place of the polarizer for filtering the beam that is transmitted to the detector and for eliminating the non-desired components therefrom. The beam emitted by the crystal and coming from the beam as reflected by the object is deflected by the splitter cube in a second direction (other than the direction to the detector), and it may optionally be sent and analyzed in that direction.

In an embodiment, the reflected beam is received by the crystal directly from the object, via focusing optics, in a direction that is at an angle relative to the direction of the incident beam. This ensures that the arrangement of the sensor remains relatively simple.

In an embodiment, the crystal is a crystal of the sillenite family, of the BiSiO, BiGeO, or BiTiO type, in which formulae Bi represents bismuth, Ge germanium, Si silicon, Ti titanium, and O oxygen.

In an embodiment, the light source is coherent, and for example it is a laser. It should be understood that such sources can be used only for measuring objects that are situated at a considerable distance, since according to another feature of the invention the coherence length remains small compared with the distance between the sensor and the object. The wavelength of the source used may lie in the green, for example, i.e. about 500 nanometers (nm) to 578 nm.

In the limit, the light source may thus be selected to have a coherence length that is long (in absolute terms), should it be desired to provide a sensor having a measurement volume with a large depth of field, e.g. for making observations in space. The sensor may then be used merely as a presence detector, for example.

Nevertheless, conversely, the light source is usually selected to have a coherence length that is short (in absolute terms). Under such circumstances, the signal received by the sensor is not only purged of all interfering information coming from elements that lie between the measured object and the sensor, but also makes it possible to provide a distance measurement that is accurate. It is thus possible to make a distance meter.

In an embodiment, the sensor also includes a device enabling an electric voltage to be applied between two parallel faces of the crystal that are perpendicular to the inlet and outlet faces thereof, so as to increase its diffraction effectiveness.

In an embodiment, the detector includes a medium suitable for fixing or recording an image, and the sensor thus constitutes an imager. By way of example, the detector may include a photosensitive medium of the complementary metal oxide semiconductor (CMOS) or CCD type, or a photographic silver plate. Advantageously, the sensor is thus an imager; it is thus suitable, in a single acquisition, for making a measurement not only at a point but rather over an entire solid angle. Thus, it is possible with a single measurement to detect all of the bodies situated at a certain distance from the sensor within the solid angle under consideration.

Preferably, the photosensitive medium is incorporated in a system enabling multiple acquisitions to be made, i.e. a camera, thus enabling multiple measurements to be performed one after another.

This embodiment makes it possible to provide detector systems for providing assistance in driving a vehicle and that are suitable for detecting the presence of obstacles in the space situated in front of the vehicle.

The invention also proposes a 3D imaging system suitable in particular for operating even when the medium surrounding the object for measurement is a diffusing medium.

This objective is achieved by the fact that the imaging system comprises an imager as defined above and further comprising a system for varying the length of the optical path traveled by the reference beam relative to the total optical path length of the incident beam plus the reflected beam. In the absence of such a system, the sensor of the invention can detect or measure an object only if it is at a certain distance from the sensor, which distance characterizes the measurement volume of the sensor. This limitation is removed in an imaging system that includes a system as specified above, in which it is possible to vary the optical path length traveled by the reference beam relative to the optical path length traveled by the incident and reflected beams.

The imaging system makes it possible in particular to constitute a 3D model of a scene, e.g. as follows:

the above-mentioned relative path lengths are caused to vary progressively and stepwise;

on each movement step, the sensor is used to perform a 3D acquisition; and

a 3D model of the measured scene is constituted by associating each image obtained during the various measurements performed with depth information deduced from the position of the sensor during the acquisition of the image.

Two main embodiments may be envisaged for varying the path length traveled by the reference beam relative to the total optical path length traveled by the incident beam and the reflected beam, and thus for varying the depth of the field of the imaging system:

In an embodiment, the system for varying the relative optical path length is a system for causing the sensor to move relative to the measured object. The measurement is then performed either by causing the imaging system to approach the measured object progressively, or by moving progressively away therefrom, or indeed by moving therealong. Either way, the positions of the imaging system relative to the measured object are indexed and measured on each of the acquisitions so as to enable the various images obtained during the successive acquisitions to be positioned relative to one another. The imaging system may include means for determining and recording its position relative to the measured object. These positions may also be estimated as a function of parameters of the system. The advantage of this embodiment is the simplicity of the system used for varying the optical path length.

In an embodiment, the system for varying the relative optical path lengths is a system that varies the length of the optical path traveled by the reference beam. Under such circumstances, without there being any need to move the sensor relative to the measured object, it becomes possible to vary the depth of the field while the imaging system is taking measurements, and thus to take successive acquisitions that provide information about different slices of the scene corresponding to successive field depths.

Finally, the invention also seeks to provide a system for making measurements through biological tissue, or a system for measuring through an atmosphere laden with particles, e.g. aerosol particles such as a fog, or indeed drops of rain.

Systems enabling such measurements to be taken may advantageously be made using a sensor or an imaging system as defined above.

### BRIEF DESCRIPTION OF THE DRAWINGS

The invention can be well understood and its advantages appear better on reading the following detailed description of embodiments given as non-limiting examples. The description refers to the accompanying drawings, in which:

FIG. 1 shows an optical coherent tomographic measurement system as described above;

FIG. 2 shows a sensor of the invention in which the filter is constituted by a polarizer;

FIG. 3 shows a sensor of the invention in which the filter is constituted by a beam-splitter cube;

FIG. 4 shows an imaging system of the invention enabling 3D information to be acquired about the measured object; and

FIG. 5 shows an image obtained by the system shown in FIG. 4 for a given measurement depth.

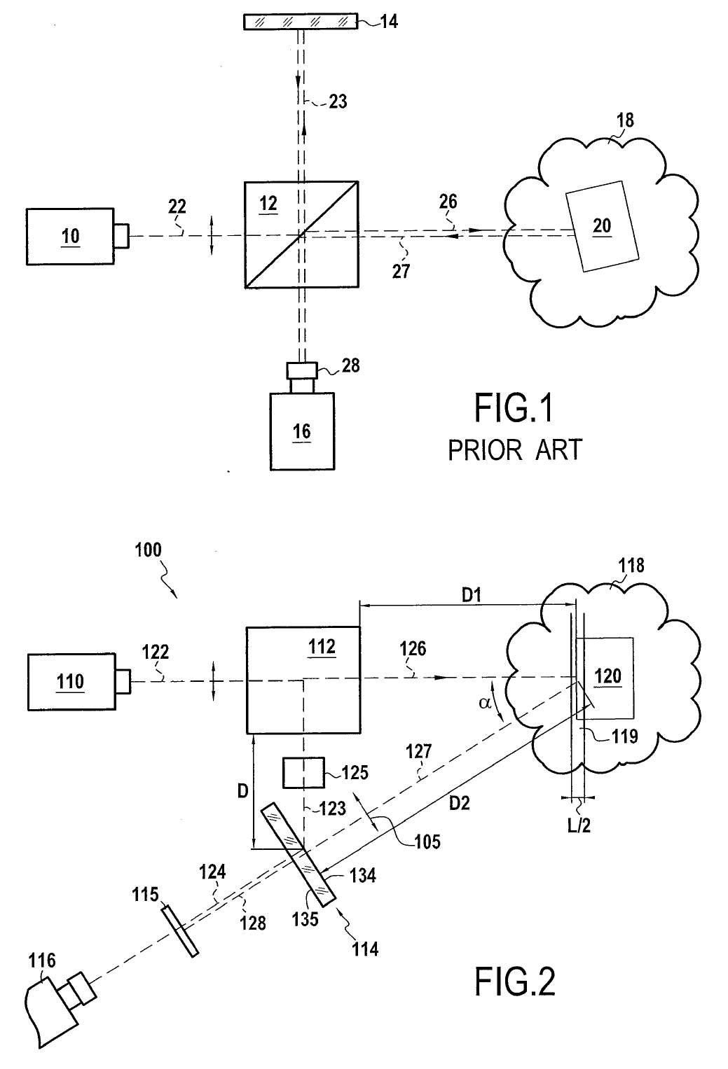

### MORE DETAILED DESCRIPTION

A sensor 100 of the invention is shown in FIG. 2.

The sensor 100 comprises a light source 110, a beam-splitter cube 112, a photorefractive crystal 114, a polarizer 115, and a detector 116.

The light source 110 is a laser source that emits a source beam 122 towards an object 120 for measurement. In the context of the invention, the light source could equally well be a laser, a laser diode, LED, etc.

The object 120 is situated in a diffusing medium 118, which may be an atmosphere charged with particles such as a fog or the atmosphere on a rainy day, or it could be a living tissue or other tissue (where measurement is also possible, a fortiori, when the medium 118 is not a diffusing medium). The splitter cube 112 lies on the path of the source beam 122 and it splits it into two beams:

a reference beam 123 that is deflected through 90° relative to the direction of the source beam 122; and

an incident beam 126 that is not deflected and that continues its journey until it reaches the object 120 for measurement.

On passing through the diffusing medium 118, and on striking the measured object 120, the incident beam 126 generates a reflected beam 127 that is reflected back towards the photorefractive crystal 114. The reflected beam 127 is picked up by the photorefractive crystal 114 via focusing optics 105 immediately after its reflection on the measured object 120 in a direction forming an angle α relative to the direction of the incident beam.

Furthermore, prior to striking the photorefractive crystal 114 to which it is sent by the splitter cube 112, the reference beam 123 passes through an optical path lengthening device 125. This device serves to cause the reference beam 123 to travel a desired distance so that the both reference beam and the incident beam plus the reflected beam travel optical paths of equal or similar length prior to reaching the photorefractive crystal 114. This condition is necessary to ensure that these two beams interfere when they meet, thereby generating a hologram in the photorefractive crystal 114.

The optical path lengthening device 125 may be constituted merely by a coil formed by winding optical fiber, with the reference beam 123 being conveyed by the optical fiber; the length of the wound fiber is then selected so that the optical path length traveled by the reference beam 123 is equal to the sum of the lengths of the optical paths of the incident beam 126 and of the reflected beam 127.

As mentioned above, the photorefractive crystal 114 being illuminated simultaneously by the reference beam 123 and by the reflected beam 127 causes a hologram to be formed inside the photorefractive crystal 114. The hologram can form only if the reference beam interferes with the reflected beam returned by the object, given the coherence length of the source beam. Consequently, a hologram is formed only for reflections formed on those portions of the object that are situated in a measurement volume 119 that is in the form of a slice and that is situated at a depth of field that is well determined relative to the sensor 100. This measurement volume is the volume in which the sum of the optical path lengths of the reflected beam and of the incident beam corresponds substantially to the optical path length of the reference beam.

More precisely, if the incident beam 126 travels a distance D1 between the splitter cube 112 and the object 120 for measurement, and if the reflected beam 127 travels a distance D2 between the object 120 and the photorefractive crystal 114, then the reflected beam will be recorded in the hologram only if the following condition is satisfied:

|D1+D2−D|<L

in which:

|x| designates the absolute value of a magnitude “x”;

D is the length of the optical path traveled by the reference beam 123; and

L is the coherence length L of the light source 110.

When the diffusing medium 118 is air, and given the refractive index of air, the depth of the measurement slice 119 is substantially equal to L/2, i.e. half the coherence length L of the light source 110. The hologram formed in the photorefractive crystal 114 is read by means of the reference beam 123 itself. On reaching the photorefractive crystal 114 via its front face 134, the reference beam 123 is diffracted and causes the crystal to emit a diffracted reference beam 124 via the rear face 135 of the crystal.

In addition, the photorefractive crystal 114 emits a transmitted reflected beam 128 from its rear face 135, which beam is constituted merely by transmitting the reflected beam 127 as received via its front face 134. The transmitted reflected beam 128 is superposed with the diffracted reference beam 124.

The photorefractive crystal 114 is arranged and cut so as to receive the reference beam 123 and the reflected beam 127 on its front face 134 in order to be able to make use of its anisotropic diffraction property. To make use of anisotropic diffraction, the photorefractive crystal is cut on the following crystallographic axes: 001, 110, and −110, and the inlet face 134 is orthogonal to the −110 axis. The polarizations of the reference beam 123 and of the reflected beam 127 are parallel to the crystallographic axis 001 of the crystal medium, with photorefractive crystals having rotary power. The thickness of the photorefractive crystal is about 2 millimeters (mm).

The rear face 135 of the photorefractive crystal 114 thus emits the diffracted reference beam 124 mixed with the transmitted reflected beam 128. These two beams reach a polarizer 115 located between the photorefractive crystal 114 and the detector 116. The photorefractive crystal 114 is used in its optical configuration for anisotropic diffraction; thus, the transmitted reflected beam 128 is polarized perpendicularly to the diffracted beam 124. The polarizer thus eliminates substantially all of the transmitted reflected beam 128 and transmits only the diffracted reference beam 124. This elimination is generally extremely effective since the remaining portion of the transmitted reflected beam 128 may be of the order of 1/10,000th of the total value of the initial transmitted reflected beam 128.

In the sensor 100, the detector 116 is a CCD camera. Naturally, other embodiments of the detector 116 could be simpler, e.g. a photodiode suitable for recording only one bit of information at a time, or some other type of linear or matrix detector, e.g. a CMOS or other matrix or strip.

In the sensor 100, the coherence length L of the light source is short compared with the distance between the sensor and the object (distance D1, or D2, these two values being more or less equal), and is equal to about ⅛th of this distance.

It follows that the measurement slice 119 has a depth (equal to L/2) that is small compared with the distance between the sensor and the object, i.e. in the present example about 1/15th of the distance between the sensor and the object. Thus, the major fraction of the interfering signals or reflections generated by the medium interposed between the sensor and the object (i.e. lying outside the measurement volume) contributes absolutely nothing to the diffracted signal 124.

Consequently, taking account also of the way the transmitted reflected beam 128 is eliminated from the beam that reaches the CCD camera 116, the image formed by the camera 116 is an image of the object that does not include the interfering reflections produced by the elements of the scene being studied that are situated closer to or further away from the sensor 100 than the measurement volume 119 under study.

The great advantage of the sensor is thus that it provides information about a measurement volume of well-known position, in spite of the presence of a diffusing medium 118 interposed between the sensor and the object, which medium can under certain circumstances prevent the human eye from seeing anything.

In addition, because the image obtained by the camera 116 does not have information reflected by the diffusing medium 118 situated in front of the measured object 120, the image that is formed by the camera 116 presents an excellent dynamic range, and as a result, in most circumstances, a single image can suffice for providing information about the object, without it being necessary to have recourse to complex signal processing (averaging the acquisition over a set of images, using the phase-shift technique, etc.).

Under such circumstances, in order to increase the effectiveness of the apparatus, it is possible to increase the power of the reference beam. This improvement enables the time resolution of the system to be improved and thus to make it operate almost in real time, being capable of operating at a rate of 20 images per second. Because of its speed of acquisition, the sensor can thus be used on a small scale for acquisitions in vivo.

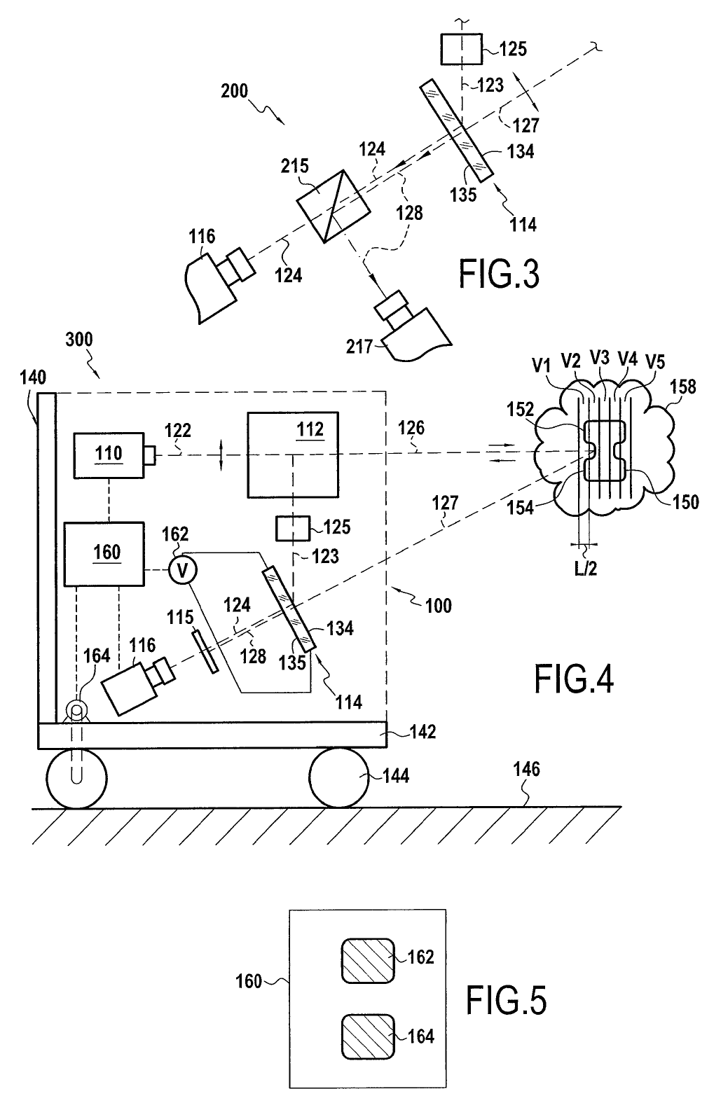

FIG. 3 shows another embodiment of a sensor 200 of the invention. Unless specified to the contrary, the elements of the sensor 200 are identical to those of the sensor 100 as described with reference to FIG. 2. The difference between the sensors 100 and 200 lies in the filter interposed between the crystal and the detector, which filter serves to eliminate the major fraction of the transmitted reflected beam 128 from the beam that is emitted by the crystal towards the detector 116.

In the sensor 200, the filter is a splitter cube 215. This cube eliminates the transmitted reflected beam 128 from the beam emitted by the crystal 114 towards the detector 116, sending the transmitted reflected beam 128 in a direction other than towards the detector 116. In the setup shown, the transmitted reflected beam 128 is reflected through a right angle. Thus, the camera or detector 116 receives only the diffracted beam 124 from the crystal. The transmitted reflected beam 128 diffracted by the separator crystal is analyzed by a second detector 217, thus making it possible to detect and/or characterize the diffusing medium. The second detector 217 is likewise a camera.

Finally, the sensor of the invention may be used to make a three-dimensional (3D) imaging system. FIG. 4 shows such an imaging system 300. The imaging system 300 is essentially constituted by a sensor 100 identical to that described above. However, the sensor 100 also has three elements that are not described above:

an electronic control unit 160;

a device 162 constituted mainly by a voltage source, enabling an electrical voltage to be applied between two parallel faces perpendicular to the inlet face 134 and the outlet face 135 of the crystal 114; and

a system 140 for varying the optical path length traveled by the reference beam relative to the total optical path length of the incident beam 126 and of the reflected beam 127.

The system 140 is constituted by a carriage 142 having wheels 144 on which the sensor 100 is mounted. The carriage 142 is driven by a motor 164 that is secured thereto.

The electronic control unit 160 is a personal computer (PC). The control unit 160 controls the light source 110, with the device 162 serving to apply a voltage to the faces of the crystal that are perpendicular to the front and rear faces 134 and 135 of the crystal 114, to the motor 164, and to the camera 116, and it is connected to these various components by wires. It makes it possible in particular to acquire different images produced by the camera 116, at different selected measurement locations, making use of an acquisition map (not shown).

A 3D model of the object is acquired as follows:

The carriage 142 is moved along the ground 146 towards an object 150 for measurement that is situated in a diffusing medium or atmosphere 158. This movement is indexed by means of a movement indexing system (not shown) that enables the positions of the sensor 100 to be recorded at the various measurement locations.

Throughout this movement, the sensor 100 is used to perform successive acquisitions. Each of the acquisitions enables an image of the object to be obtained, and more precisely an image of the section of the object that lies in the measurement volume of the sensor 100. This image may also include reflections produced by particles in the diffusing medium 158 that lies within the measurement volume.

Movement of the sensor 100 serves to move the measurement volume. One measurement method, as shown in FIG. 4, consists in causing the imaging system 300 to advance between two acquisitions through a distance that is equal to the depth of the measurement volume of the sensor 100, i.e. L/2, where L is the coherence length of the light source 110.

A 3D model of the measured scene can then be produced by recording successive images produced by the sensor 100 for each of the successively measured measurement volumes V1 to V5. Naturally, obtaining the 3D model requires the coordinates of the pixels of the acquired image to be determined in the plane perpendicular to the measurement direction (to the propagation direction of the incident beam). The value of the depth coordinate in the measurement direction is obtained from the position of the sensor 100 as recorded at the time of acquisition.

FIG. 5 thus shows the image that the sensor 100 serves to acquire during the first acquisition, for which the measurement volume V1 is positioned level (in the measurement direction) with the front face of the measured object 150.

Since the front face of the object 150 presents two projections 152 and 154, the image 160 has two zones 162 and 164 in which the presence of the object has been detected, correspondingly respectively to those two projections 152 and 154.

Obtaining 3D digital models constitutes an application with considerable added value for a sensor or an imaging system of the invention. It should be observed that an advantageous embodiment is one in which the measurement direction or the direction in which the incident beam is projected is oblique relative to the travel direction of the vehicle on which the sensor is mounted, forming an acute angle, e.g. 45°, relative thereto. Under such circumstances, the movement of the vehicle enables the 3D model of the volume situated close to the vehicle to be produced along the path it travels.

In another application, a sensor of the invention is mounted on board a moving body such as a motor vehicle, a boat, etc., and enables the shape of stationary or moving objects present in the proximity of the body to be detected and determined. The sensor thus provides safety information that is essential during movements of the moving body.

Finally, the sensor of the invention may be used for producing a precision distance meter. Under such circumstances, the sensor is provided with a light source having a short coherence length, and a reference beam of considerable intensity. The sensor can be used in particular for measuring the positions of targets, where the targets are selected to be highly reflecting.

What is claimed is:

1. A sensor for remotely detecting an object, the sensor comprising:
a light source suitable for emitting a source light beam;
a beam splitter suitable for receiving the source light beam and for splitting it into an incident beam and a reference beam, which beams are transmitted respectively in two distinct directions;
a photorefractive crystal suitable for recording a hologram on receiving the reference beam and a reflected beam reflected by an object illuminated by the incident beam, the two beams interfering, and for playing back the hologram in a diffracted beam that is emitted when the crystal is illuminated by the reference beam, the crystal being cut and located in the sensor in such a manner as to enable the reference beam to be diffracted anisotropically, thereby causing the diffracted beam to be emitted with polarization perpendicular to the polarization of the reflected beam transmitted by the crystal;
a detector suitable for recording information on receiving the diffracted beam; and
a polarization filter interposed between the crystal and the detector, and suitable for eliminating from the beam emitted by the crystal towards the detector, the major fraction of the transmitted reflected beam as transmitted by the crystal on receiving the reflected beam, such that the detector mainly receives from the crystal only the diffracted beam;
wherein the light source has a coherence length that is short relative to the distance between the sensor and the object.

2. A sensor according to claim 1, wherein the light source and the detector are suitable for operating substantially continuously, such that when the sensor is in operation, the hologram is formed and read simultaneously and continuously.

3. A sensor according to claim 1, wherein the filter comprises a polarizer suitable for eliminating the major fraction of the transmitted reflected beam from the beam that is emitted by the crystal towards the detector.

4. A sensor according to claim 1, wherein the filter comprises a polarization splitter cube suitable for separating the major fraction of the transmitted reflected beam from the diffracted beam in the beam that is emitted by the crystal towards the detector, and for directing said major fraction of the transmitted reflected beam in a direction other than towards the detector.

5. A sensor according to claim 4, further including a second detector for detecting and/or characterizing the diffusing medium, and suitable for receiving the signal directed by the splitter cube in said direction other than towards the detector.

6. A sensor according to claim 1, wherein the reflected beam is received by the crystal directly from the object via focusing optics, in a direction that is at an angle relative to the direction of the incident beam.

7. A sensor according to claim 1, wherein the crystal is a crystal of the sillenite family, of the BiSiO, BiGeO, or BiTiO type, in which formulae Bi represents bismuth, Ge germanium, Si silicon, Ti titanium, and O oxygen.

8. A sensor according to claim 1, wherein the light source is coherent, and is for example a laser.

9. A sensor according to claim 1, wherein the light source is a LED or a halogen lamp.

10. A sensor according to claim 1, further including a device enabling an electrical voltage to be applied between two parallel faces of the crystal perpendicular to the inlet and outlet faces thereof, so as to increase its diffraction effectiveness.

11. A sensor according to claim 1, wherein the detector includes a support enabling an image to be fixed or recorded, so that the sensor thus constitutes an imager.

12. An imaging system comprising a sensor according to claim 11 that includes a system for varying the length of the optical path traveled by the reference beam relative to the length of the total optical path traveled by the incident beam and by the reflected beam, so as to constitute a 3D imaging system.

13. An imaging system according to claim 12, wherein the system for varying the relative optical path length is a system for causing the sensor to move relative to the measured object.

14. An imaging system according to claim 12, wherein the system for varying the relative optical path length is a system for varying the length of the optical path traveled by the reference beam.

15. The use of a sensor according to claim 1 for measuring through biological tissue.

16. The use of an imaging system according to claim 12 for measuring through biological tissue.

17. The use of a sensor according to claim 1 for measuring through an atmosphere laden with particles, e.g. aerosol particles such as a fog, or indeed drops of rain.

18. The use of an imaging system according to claim 12 for measuring through an atmosphere laden with particles, e.g. aerosol particles such as a fog, or indeed drops of rain.
